(19) United States
(12) Patent Application Publication
(10) Pub. No.: US 2025/0248560 A1
(43) Pub. Date: Aug. 7, 2025

(54) DEVICE FOR HEATING LIQUID FOODSTUFFS

(71) Applicant: Franke Kaffeemaschinen AG, Aarburg (CH)

(72) Inventors: Simon Mueller, Hirschtal (CH); Nico Ronny Gradwohl, Otten (CH)

(73) Assignee: Franke Kaffeemaschinen AG, Aarburg (CH)

(21) Appl. No.: 19/027,074

(22) Filed: Jan. 17, 2025

(30) Foreign Application Priority Data
Feb. 5, 2024 (DE) 102024103201.4

(51) Int. Cl. A47J 31/44; A47J 31/46

(52) U.S. Cl. CPC A47J 31/4485; A47J 31/4489; A47J 31/461; A47J 31/469

(57) ABSTRACT

A device for heating liquid foods, in particular milk, includes a pumping device for transferring the liquid food from a storage container to an outlet and a heating element arranged between the pumping device and the outlet. The heating element is designed as a steam-heated heat exchanger which has first and second fluidically separate flow paths that are in thermal contact with one another. The first flow path can be connected, or is connected, at the inlet side thereof to a steam generator, and the second flow path can be connected, or is connected, at the inlet side thereof to the pumping device and at the outlet side thereof to the outlet.

### CROSS-REFERENCE TO RELATED APPLICATIONS

This application claims priority to German Patent Application No. 10 2024 103 201.4, filed Feb. 5, 2024, which is incorporated herein by reference as if fully set forth.

### TECHNICAL FIELD

The present invention relates to a device for heating liquid foods, in particular milk, comprising a pumping device for transferring the liquid food from a storage container to an outlet, and a heating element arranged between the pumping device and the outlet.

### BACKGROUND

In hot beverage machines, such as fully automatic coffee machines, beverage components such as milk or other liquid foods are stored in storage containers and heated, possibly with frothing, when dispensing. Two distinct technologies have become established for heating: the medium can either pass through a heat exchanger or flow heater, such as a thermoblock, for example, during which it is heated, or hot steam can be mixed into the medium during dispensing (steam injection). A combination of the aforementioned methods is also known in the art. Hence a two-stage heating process for milk is described in EP 2 583 596 B1. In a first heating stage, the milk is heated using a flow heater. Steam is then supplied for additional heating in a second heating stage.

A flow heater requires a relatively large surface area for temperature exchange, in order to transfer the necessary energy. This results in a large volume of milk that has to be rinsed off and cleaned. The volume of milk remaining in the system is discarded during each cleaning or rinsing cycle.

When heating milk or other protein-rich foods, deposits can form on the inner walls of the flow heater. The rate of deposition in this case depends primarily on the temperature and the duration over which the flow heater is in contact with milk or other liquid foods. Consequently, the temperature must be limited to approximately 65° C. Although a reduction in contact time can be achieved through regular rinsing, this results in significant milk and energy loss. This means that maximum milk temperatures of roughly 55° C. are possible a conventional thermoblock.

Due to its design, a thermoblock has a high thermal mass. This means that cold milk cannot be dispensed through the thermoblock, even if it is not actively heated. If cold milk is to be dispensed in addition to hot milk, an additional switching valve is required.

The advantage of a flow heater is that fine-pored milk foam produced while cold is not destroyed by indirect heating and largely retains its properties.

The condensation energy of steam is used in direct steam injection to heat the milk. Heating by means of steam can take place in a very short time and in a compact space.

However, steam injection is unsuitable for heating milk foam, as milk foam produced when cold is either destroyed or at least its visual appearance is significantly degraded by the injection of steam. Furthermore, steam injection can cause noise and impair the dispensing quality due to steam hammer effects.

### SUMMARY

An object of the invention is to provide an improved device for heating liquid foods.

The problem is solved by a device for heating liquid foods having one or more of the features disclosed herein. Advantageous embodiments can be inferred from the description and claims that follow.

With a device of the kind referred to above, it is provided according to the invention that the heating element is designed as a steam-heated heat exchanger which has two fluidically separate flow paths that are in thermal contact with one another, wherein a first flow path can be connected, or is connected, at the inlet side to a steam generator, and a second flow path can be connected, or is connected, at the inlet side to the pumping device and at the outlet side to the outlet.

By regulating the steam supply, the heating output can be easily controlled. At the same time, the high condensation energy of steam allows for a higher energy density compared with electric heating, so that the heat exchanger can have a very compact design. A steam-heated heat exchanger can be executed with a comparatively low thermal mass.

Due to the low thermal mass and the controllable steam supply, the steam-heated heat exchanger can be brought to a temperature that non-critical for the formation of deposits at the end of a product dispensing operation, for example by preemptively shutting off the steam supply. This approach enables a higher product temperature to be achieved on the one hand. On the other hand, cold products can also be dispensed without requiring an additional switching valve.

The connection between the first flow path and the steam generator may be direct or by means of a valve mechanism. Similarly, the connection between the second flow path and the outlet can be direct or switched.

The first flow path can preferably be connected to a steam control device, in particular a dosing valve, at the input side or the output side. This facilitates simple control or regulation of the steam supply and, consequently, the heating output.

The device according to the invention can preferably be equipped with a frothing mechanism that can be operated as needed. A mechanism of this kind can, for example, be implemented by an air supply upstream of the pumping device and a flow resistance device, such as an orifice plate or a static mixer, downstream of the pumping device. By arranging the air supply on the suction side of the pumping device and increasing the pressure in the pumping device through the flow resistance, the liquid food is frothed. By closing the air supply, the frothing device can be deactivated. The foam consistency can be influenced by controlling the air supply and/or the performance of the pumping device. The frothing process is particularly effective when a gear pump is used as the pumping device.

In a preferred development of the invention, it is provided that on the outlet side the first flow path can be connected, or is connected, to a food line leading from the second flow path to the outlet, preferably via a three-way connector. Consequently, residual steam behind the primary circuit of the heat exchanger can be added to the heated food and additional secondary heating is therefore achieved. The heat exchanger can be compactly designed for only a moderate heating output. With a smaller steam supply, the steam condenses within the heat exchanger and heat is transferred to the liquid food. On the other hand, if the heating output is raised by increasing the steam supply, residual steam that is not condensed is automatically injected and therefore secondary heating takes place.

For firm foam, for example, minimal heating output is required, allowing the steam to fully condense within the heat exchanger. The fact that the condensed steam (water) is subsequently mixed into the foam does not affect the consistency of the foam. As a result, the firm foam is not destroyed, unlike what would happen with the addition of steam addition. In the case of liquid foam or unfrothed milk, on the other hand, a higher heating output is required. In this case, the heat exchanger can be designed in such a manner that it would not alone provide sufficient power in this case. Therefore, the uncondensed steam is subsequently mixed with the milk or the liquid milk foam and thereby ensures additional heating.

Instead of adding condensed steam (water) to the frothed food product, the connection between the outlet side of the first flow path and the food line leading to the outlet can be made via a valve arrangement. This allows the first flow path to be connected alternatively to a drain, so that the condensed water is diverted during the heating of firm milk foam, rather than being added to the milk foam.

The second flow path can also be optionally connected to the outlet or a drain via a (further) valve arrangement. In this way, the second flow path of the heat exchanger can be connected to the drain for rinsing, so that residual milk and/or rinsing fluid is not dispensed to the outlet and can accidentally end up in a user's drinking vessel. The second flow path of the heat exchanger can also be connected to the drain to carry out automated cleaning cycles using specialized cleaning agents.

In a particularly preferred embodiment, the device can be equipped with a steam control device arranged on the inlet or outlet side of the first flow path and a frothing mechanism that can be operated as needed, and with a controller programmed to operate in a first operating mode, to activate the frothing mechanism and/or the pumping device to produce a firm food foam and to control the steam control device to supply a first, lower amount of steam, and in a second operating mode, to activate the frothing mechanism and/or pumping device to produce liquid food foam or to deactivate the frothing mechanism for dispensing unfrothed food, and to control the steam control device to deliver a second, higher amount of steam.

In this case, it may be advantageously provided that the first, lower amount of steam is adjusted so that the steam fully condenses within the heat exchanger, and the second, higher amount of steam is adjusted so that steam still exits on the outlet side of the first flow path, said steam being directed via a three-way connector to a food line leading from the second flow path to the outlet.

The two flow paths of the heat exchanger can be configured coaxially, wherein the first flow path preferably surrounds the second flow path. This results in a particularly compact and energy-efficient design.

The two flow paths of the heat exchanger can be arranged in a counterflow configuration. This enables a particularly effective heat transfer from the steam to the liquid food to be achieved.

The device can be equipped with a temperature sensor communicating with the outlet of the second flow path to measure the temperature of the heated liquid food. This enables measurement of the product temperature and, if necessary, regulation of the steam supply and/or the performance of the pumping device to achieve a specified output temperature.

The first flow path can be connected to a cold water supply on the inlet side via a valve. This allows the heat exchanger to be rinsed with cold water and cooled for dispensing a cold food product.

### BRIEF DESCRIPTION OF THE DRAWINGS

Further advantages and properties of the invention will emerge from the following description of exemplary embodiments with the help of the figures. In the drawings:

FIG. 1 shows a water flow schematic of a device according to the invention with a steam-heated heat exchanger for heating milk in a first exemplary embodiment;

FIG. 2 shows a second exemplary embodiment with an electric flow FIG. 2 heater upstream of the steam-heated heat exchanger;

FIG. 3 shows a third exemplary embodiment with a control valve arranged downstream of the primary circuit of the heat exchanger;

FIG. 4 shows a fourth exemplary embodiment with a valve arrangement arranged downstream of the primary circuit of the heat exchanger, which allows condensed steam to be directed into a drain; and

FIG. 5 shows a fifth exemplary embodiment in which the primary circuit of the heat exchanger can be connected to a cold water supply on the inlet side via a valve.

### DETAILED DESCRIPTION

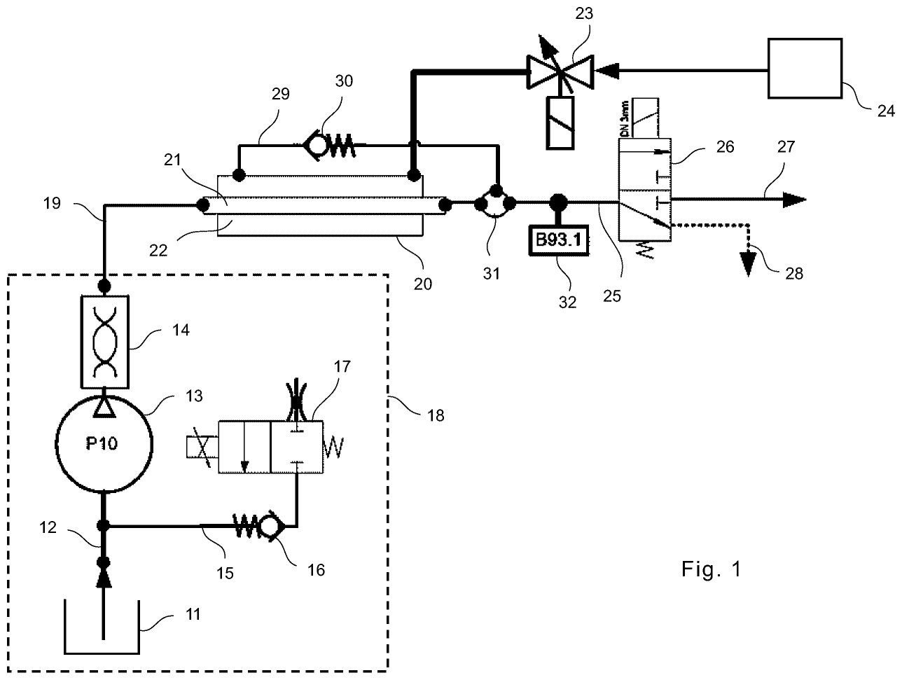

A first exemplary embodiment of a device for heating milk is schematically illustrated in FIG. 1. The milk is stored in a storage container 11. Using a suction line 12, said milk can be conveyed by means of a milk pump 13 towards a beverage outlet 27. The pressure side of the milk pump 13 passes through a static mixer 14 (helical mixer), which acts as a flow resistance and thereby contributes to an increase in pressure within the milk pump 13. An air supply line 15 with a check valve, preventing milk from escaping, and an air valve 17 for controlling the air supply lead into the suction line 12. The air valve may be an intermittently operated switching valve or a throttle valve, such as a needle valve, for example. The storage container 11 and the milk pump 13 are housed together in a refrigerator 18, so that the milk remains chilled in the storage container 11 and along the subsequent transport path.

The milk pumped by the milk pump 13 flows through a delivery line 19 into a heating device 20, which is designed as a steam-heated heat exchanger. Said heat exchanger is coaxially constructed with an inner flow path 21, through which milk flows, and an outer flow path 22 which is connected on the inlet side to a steam generator 24, only schematically indicated here, such as a steam boiler, via a control valve 23, and steam flows through it.

The outlet of the inner flow path 21 through which milk passes is connected via a milk line 24 and an optional 3/2-way valve, which acts as a switching valve, to the beverage outlet 27, through which heated milk or milk foam is dispensed in portions into a drinking vessel placed under the beverage outlet. The switching valve 26 is used to connect the milk line 25 to a drain 28 or a drainage vessel for emptying, for the purpose of cleaning or rinsing.

The outlet of the outer flow path 22 through which steam flows is connected via a line 29 and a check valve 30 to the milk line 25 via a three-way connector 31. The three-way connector 31 may be configured as a T-joint with or without an integrated mixing chamber. Through the line 29, any remaining uncondensed steam, after passing through the outer flow path of the heat exchanger 20, is introduced into the milk line, automatically providing additional heating for the milk there that has been preheated in the heat exchanger.

The check valve prevents milk from being drawn into the steam line 29 during the cooling of the heat exchanger and the condensation of any residual steam remaining in the outer path 22.

A temperature sensor 32 connected to the milk line 25 is used to measure the milk temperature before the outlet 27, allowing active regulation of the milk temperature. The milk temperature can be adjusted by controlling the amount of steam via the control valve 23, as well as by regulating the amount of milk by adjusting the performance of the milk pump 13, or by a combination of these measures.

By introducing air into the suction line 12 via the air supply line 15 on the suction side of the milk pump 13, milk foam is produced within the milk pump 13 and through the static mixer 14. The consistency of the milk foam can be adjusted by regulating the amount of air.

If firm milk foam is to be produced, more air is supplied by keeping the air valve open longer (e.g. by adjusting the duty cycle in a pulsed control) or opening it wider (in the case of a throttle valve). In this case, the milk foam should not be disrupted by the addition of steam downstream of the heat exchanger. The amount of steam is therefore adjusted via the control valve 23, so that the steam fully condenses within the heat exchanger 20. Due to the higher air content, firm milk foam has a significantly lower heat capacity, meaning that the reduced amount of steam is sufficient for heating.

On the other hand, if liquid milk foam is to be produced, the air supply is reduced, allowing less air to enter. Since the milk foam already has a relatively liquid consistency, the injection of steam downstream of the heat exchanger does not significantly affect its consistency. The amount of steam is therefore adjusted via the control valve 23, to allow more steam to flow through the heat exchanger 20, where only part of the steam condenses. The remaining steam is injected into the heated milk foam via the three-way connector 31 downstream of the heat exchanger 20, resulting in additional reheating with steam. Liquid milk foam can therefore be dispensed at a higher temperature than would be possible with the use of an electric flow heater.

In order to dispense unfrothed milk, the air supply is closed and the amount of steam is likewise increased compared with firm milk foam. Since unfrothed milk has a higher heat capacity than liquid milk foam due to the absence of air, the amount of steam used to heat unfrothed milk can be greater than that for liquid milk foam. This allows a larger quantity of steam, or steam at a higher final temperature, to be injected into the heated milk, resulting in stronger reheating. As a result, milk can be dispensed at a significantly higher temperature than is achievable with an electric flow heater.

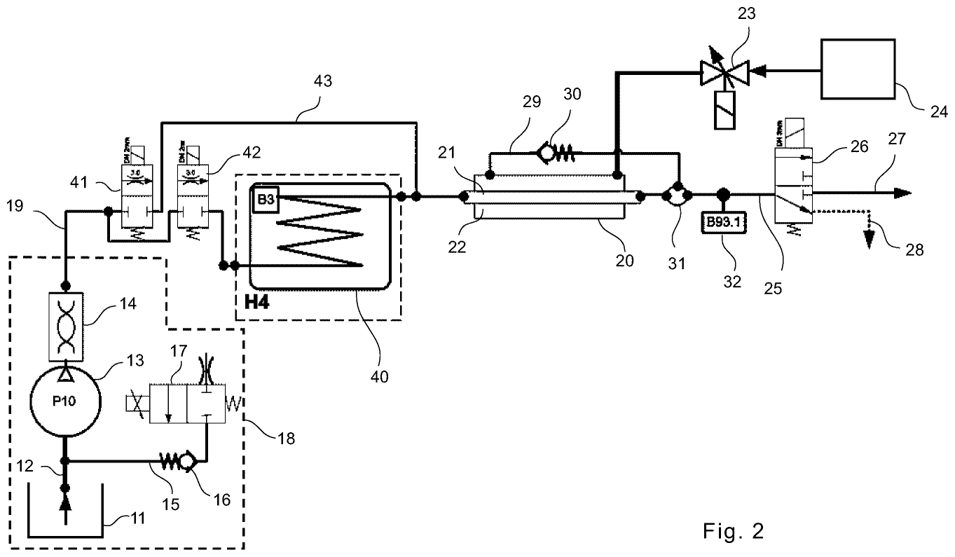

In FIG. 2, a variant is shown as the second exemplary embodiment, in which, based on the first exemplary embodiment, a conventional electric flow heater 40, in the form of a thermoblock, is additionally arranged between the milk pump 13 and the heat exchanger 20. With the now three-stage heating process (electric flow heater, steam-heated heat exchanger, and subsequent steam injection), the output temperature can be further increased and/or the amount of steam reduced, so that less water is added to the milk.

Since the flow heater 40 has a higher thermal mass than the heat exchanger 20, it cannot cool down again quickly after a product has been dispensed. In the event that cold milk or cold milk foam is to be dispensed, a valve arrangement with two parallel shut-off valves 41, 42 is therefore provided, with which the milk, whether frothed or unfrothed, can be routed from the milk pump either through the flow heater 40 or via a bypass line 43, bypassing the flow heater, directly to the heat exchanger 20. Instead of two individual shut-off valves, a 3/2-way valve can, of course, also be used to switch the flow path between the flow heater 40 and the bypass line 43.

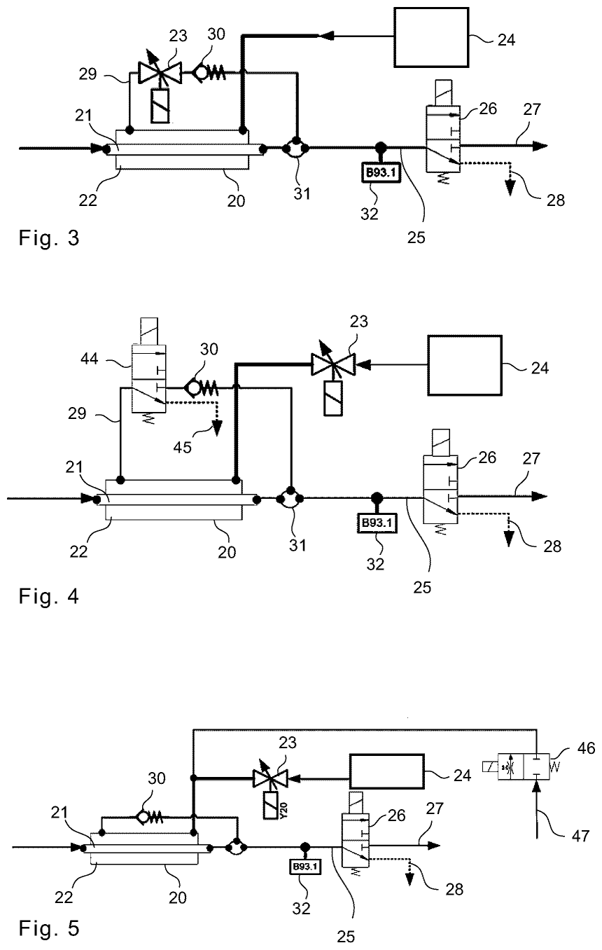

In FIG. 3, a variant is shown as the third exemplary embodiment, in which, based on the first exemplary embodiment, the control valve 23 for adjusting the amount of steam directed through the outer flow path 22 of the heat exchanger 20 is now arranged downstream of the outer flow path 22 in the line 29 between the heat exchanger 20 and the three-way connector 31, instead of between the steam generator 24 and the outer flow path 22 of the heat exchanger 20.

In FIG. 4, a variant is shown as the fourth exemplary embodiment, in which, based on the first exemplary embodiment, the outer flow path 22 through which steam flows can be connected via a switching valve 44 either to the three-way connector 31 or alternatively to a drain 45. This allows for the option of either injecting the residual steam into the heated milk for reheating or discarding it via the drain 45. Discarding it is particularly useful when the amount of steam has been reduced to the point where it is fully or mostly condensed within the heat exchanger 20 and/or when firm milk foam is to be produced, which should not be affected by steam injection, and/or where the condensed water in the flow heater should not be directed into the beverage.

In the event that only condensed water, in other words steam condensate, is to be directed to the drain 45, a condensate separator can be used in addition to, or instead of, the switching valve 44.

In FIG. 5, a variant is shown as the fifth exemplary embodiment, in which, based on the first exemplary embodiment, in which the outer flow path 22 of the heat exchanger 20 can be connected on the inlet side via a 3/2-way valve 46 either to the steam generator or to a cold water supply line 47. This allows the heat exchanger to be rinsed with cold water and thereby cooled down after a product has been dispensed. This may serve as a supplementary measure, if cold, i.e. unheated, milk or milk foam is to be dispensed subsequently.

It is of course possible and within the scope of the present invention to combine the modifications and additions shown in FIGS. 2 to 5 with one another in any desired manner.

1. A device for heating liquid foods, comprising:
a pumping device (13) for transferring the liquid food from a storage container (11) to an outlet (27);
a heating element (20) arranged between the pumping device (13) and the outlet (27); and
the heating element (20) comprises a steam-heated heat exchanger which has first and second fluidically separate flow paths (21, 22) that are in thermal contact with one another, the first flow path (22) is adapted to be connected, or is connected, at an inlet side thereof to a steam generator (24), and the second flow path (21) is adapted to be connected, or is connected, at an inlet side thereof to the pumping device (13) and at an outlet side thereof to the outlet (27).

2. The device as claimed in claim 1, wherein the first flow path (22) is connected to a steam control device (23) on the inlet side thereof or on an outlet side thereof.

3. The device as claimed in claim 2, wherein the steam control device (23) comprises a metering valve.

4. The device as claimed in claim 1, further comprising a selectively operable frothing mechanism (14, 15, 17) connected to the pumping device.

5. The device as claimed in claim 1, wherein the first flow path (22) is adapted to be connected, or is connected, on an outlet side thereof to a food line (25) leading from the second flow path (21) to the outlet.

6. The device as claimed in claim 5, wherein the first flow path (22) is adapted to be connected, or is connected, on the outlet side thereof to the food line (25) leading from the second flow path (21) to the outlet via a three-way connector (31).

7. The device as claimed in claim 5, wherein the second flow path (21) is connectable to the outlet (27) or a drain (28) via a first valve arrangement (26).

8. The device as claimed in claim 7, wherein the connection between an outlet side of the first flow path (22) and the food line (25) leading to the outlet (27) is made via a second valve arrangement (45), through which the first flow path (22) is adapted to be connected alternatively to a drain (45).

9. The device as claimed in claim 1, further comprising a steam control device (23) arranged on the inlet side or an outlet side of the first flow path (22), a selectively operable frothing mechanism (14, 15, 17), and a controller programmed to operate in a first operating mode, to activate at least one of the frothing mechanism (14, 15, 17) or the pumping device (13) to produce a firm food foam and to control the steam control device (23) to supply a first, lower amount of steam, and in a second operating mode, to activate at least one of the frothing mechanism (14, 15, 17) or the pumping device (13) to produce liquid food foam or to deactivate the frothing mechanism (14, 15, 17) for dispensing unfrothed food, and to control the steam control device (23) to deliver a second, higher amount of steam.

10. The device as claimed in claim 9, wherein the first, lower amount of steam is adjusted so that the steam fully condenses within the heat exchanger (20), and the second, higher amount of steam is adjusted so that the steam still exits the outlet side of the first flow path (22), said steam being directed via a three-way connector (31) to a food line (25) leading from the second flow path (21) to the outlet (27).

11. The device as claimed in claim 1, wherein the first and second flow paths (21, 22) are configured coaxially.

12. The device as claimed in claim 11, wherein the first flow path (22) surrounds the second flow path (21).

13. The device as claimed in claim1, wherein the first and second flow paths (21, 22) are arranged in a counterflow configuration.

14. The device as claimed in claim 1, further comprising a temperature sensor (32) communicating with the outlet side of the second flow path (21) to measure a temperature of the heated liquid food.

15. The device as claimed in claim 1, further comprising a valve (46) by which the first flow path (22) is adapted to be connected to a cold water supply line (47) on the inlet side.
